(19) United States
(12) Patent Application Publication
(10) Pub. No.: US 2012/0003528 A1
(43) Pub. Date: Jan. 5, 2012

(54) SQUARE-CELL BATTERY AND MANUFACTURING METHOD FOR SAME

(75) Inventors: Masao Kusukawa, Sumoto-shi (JP); Atsuhiro Funahashi, Osaka (JP); Yoshitaka Shinyashiki, Kobe-shi (JP); Masayuki Fujiwara, Kasai-shi (JP); Hitoshi Maeda, Sumoto-shi (JP); Yuji Tani, Sumoto-shi (JP)

(73) Assignee: SANYO ELECTRIC CO., LTD., Osaka (JP)

(21) Appl. No.: 13/172,376

(22) Filed: Jun. 29, 2011

(30) Foreign Application Priority Data
Jun. 30, 2010 (JP) 2010-150308

(51) Int. Cl. H01M 2/02; B32B 38/10; B32B 38/18; H01M 2/04; H01M 2/30

(52) U.S. Cl. 429/179; 156/293; 156/153

(57) ABSTRACT

The present invention aims to provide a battery that includes electrode terminals passing through a lid, in which the lid and electrode terminals are securely insulated and sealed while being solidly fixed to each other without using an insulation-forming body or packing. To this end, a lid has upwardly-protruding protrusions formed therein. Through-holes are formed in the protrusions and tapered so as to become narrower toward the top relative to the bottom. Fitting portions forming the middle portions of a cathode terminal board and an anode terminal board are tapered to fit into the through-holes. Heat-welding tape is introduced between the outer faces of the fitting portions and the inner faces of the through-holes. The heat-welding tape is made up of an insulating substrate with heat-welding layers layered on both sides thereof.

### TECHNICAL FIELD

The present invention relates to a battery and a manufacturing method therefor. In particular, the present invention concerns a power supply, or to a high-capacity square-cell battery used as a back-up power supply for robots, electric vehicles, and so on.

### BACKGROUND ART

In recent years, batteries have been used not only in portable telephones, laptop computers, PDAs and similar mobile information terminals, but also as back-up power supplies for robots, electric vehicles, and so on. For such purposes, a high-capacity battery is used, with ever-greater capacities being sought.

Lithium-ion secondary-cell batteries have high energy density and are applicable to the relatively high-capacity uses suggested above.

Generally speaking, a lithium-ion secondary-cell battery is made up of an electrode assembly with anodes and cathodes having separators disposed therebetween. The electrode assembly is contained in an outer casing that has an opening, and the opening is closed by a lid. Electrode terminals connected to the electrode assembly pass through the lid.

A battery, particularly a square cell, with a high capacity and that can charge and discharge high-intensity current has a cathode terminal and an anode terminal, both made of metal and made to pass through a metal lid. In such a type of battery, the electrode terminals passing through the lid must be insulated from the lid, yet remain fixed thereto.

For this purpose, Patent Literature 1 discloses a battery with an electrode terminal in the shape of a screw that is screwed into an insulating body in the shape of a rectangular prism. Furthermore, the insulation-forming body is fitted into a through-hole formed in the casing, to which the electrode terminals are securely fastened with a nut. In this case, in order to seal the electrode terminals or the insulating components to the casing, packing is applied to the top and bottom of the insulating body, which is then clamped using the nut.

Additionally, Patent Literature 2 discloses a lithium battery with electrode terminals and a casing lid, each of which has undergone surface treatment with a triazine dithiol compound or with a silane coupling agent, and has an insulating seal, made of polyphenyl sulfide, adhering thereto. In such a battery, insulation and sealing is maintained between the casing lid and the terminals passing therethrough without using an insulation-forming body or packing. Also, the electrode terminals are strongly fastened to the casing lid.

### CITATION LIST

### Patent Literature

### Patent Literature 1

Japanese Patent Application Publication No. 2009-87613

### Patent Literature 2

Japanese Patent Application Publication No. 2008-27823

### SUMMARY OF INVENTION

### Technical Problem

However, according to the above-described technology of Patent Literature 2, the treatment applied to the surface of the electrode terminals and to the surface of the casing lid causes a compound monolayer to form on said surfaces. Therefore, there is a possibility that the monolayer may connect and conduct between the electrode terminals and the lid when the two components are joined during the process in which the insulating seal member is applied thereto.

### Solution to Problem

In consideration of the above-described problem, the present invention aims to provide a battery that includes electrode terminals passing through a lid, in which the lid and electrode terminals are securely insulated and sealed while being solidly fixed to each other without using an insulation-forming body or packing.

In order to achieve this aim, the present invention provides a battery comprising: a casing having an opening; an electrode assembly contained in the casing and in which are disposed a cathode plate and an anode plate interleaved with a separator; an electrode terminal connected to the cathode plate or to the anode plate; a lid closing the opening and having a through-hole formed therein such that the electrode terminal passes therethrough; and a heat-welding sheet having a laminate structure in which at least one heat-welding layer is laminated on an insulating substrate; wherein a passing portion of the electrode terminal passing through the through-hole is shaped so as to fit the through-hole, and the heat-welding sheet has been introduced between outer faces of the passing portion of the electrode terminal and inner faces of the through-hole and provides insulation and sealing between the electrode terminal and the lid.

Alternatively, in the present invention, the through-hole is ideally tapered so as to decrease in width toward the distal end relative to the electrode assembly, and the passing portion of the electrode terminal is ideally tapered to fit the through-hole.

Additionally, in the present invention, the lid is preferably made with a protrusion protruding from an outside face thereof, and the through-hole may be a hole in the protrusion.

Also, the outer faces of the electrode terminal have desirably been roughened by a treatment.

In a square-cell battery with a casing in the shape of rectangular prism, there is a great need to have the electrode terminals pass through a metal lid while being securely held thereto. The present invention is highly effective in such applications.

A battery manufacturing method pertaining to the present invention comprises: a fitting step of fitting the electrode terminal in the through-hole formed in the lid such that the heat-welding sheet is interposed; and a welding step of welding the heat-welding sheet by heating the lid while the electrode terminal is fitted in the through-hole.

Also, the manufacturing method ideally further comprises an adhering step of causing the heat-welding sheet to adhere to the outer faces of the electrode terminal by welding, the adhering step being performed before the fitting step.

### Advantageous Effects of Invention

According the present invention as described above, a heat-welding sheet made up of heat-welding layers layered on both principal surfaces of an insulating substrate is introduced between the outer faces of electrode terminals and the inner faces of the through-holes. An insulating seal is then formed by the heat-welding sheet. Thus, a good-quality seal is formed between the outer faces of the electrode terminals and the inner faces of the through-holes, and the terminals are solidly and securely fastened to the lid. Furthermore, given the introduction of the insulating substrate, the electrode terminals and the lid are insulated with sufficient reliability.

Therefore, according to the present invention, the electrode terminals and the lid can be well-insulated and securely fixed without using an insulation-forming body or packing.

Also, if the through-holes are tapered so as to become narrower toward the distal end, away from the battery body, and the fitting portions of the electrode terminals are also tapered to fit the through-holes, then simply by pressing the electrode terminals toward the lid, pressure can more easily be applied between the outer faces of the fitting portions and the inner faces of the through-holes during the welding process of the fitting portions and through-holes pressing and sandwiching the heat-welding sheet.

Furthermore, protrusions are formed in the outer face of the lid. The contact surface area between the contact electrodes and the lid can be extended by forming the through-holes inside the protrusions. Accordingly, the sealing between the electrode terminals and the lid is improved, and the fixing thereof made more secure.

The adhesion of the heat-welding layers is improved by applying a surface roughening treatment to the outer faces of the electrode terminals.

According to the battery manufacturing method of the present invention as described above, a fitting step and a welding step are performed on the electrode terminals and the lid. This provides reliable insulation while securely fixing the two components.

Also, in an adhering step performed before the fitting step, the heat-welding sheets are welded and thus caused to adhere to the outer faces of the electrode terminals. Thus, the heat-welding sheets can more easily be introduced between the through-holes in the lid and the electrode terminals during the fitting step.

### BRIEF DESCRIPTION OF DRAWINGS

FIG. 1 is a perspective diagram showing the configuration of a battery 1 pertaining to the Embodiment.

FIG. 2 is an assembly diagram of the battery 1.

FIG. 3 is a diagram showing the configuration of a laminated electrode assembly 10 embedded in the battery 1.

FIGS. 4A, 4B, and 4C are diagrams showing the configuration of a lid 20.

FIGS. 5A, 5B, and 5C are diagrams showing the shape of a cathode terminal board 40.

FIG. 6A is a diagram showing the shape of heat-welding tape 60, and FIG. 6B is a cross-sectional diagram thereof.

FIGS. 7A and 7B are cross-sectional diagrams showing the cathode terminal board 40 with heat-welding tape 60 adhering thereto, being fit and pressed into a through-hole 25 of the lid 20.

### DESCRIPTION OF EMBODIMENTS

An Embodiment of the present invention is detailed below.

A battery 1 pertaining to an Embodiment of the present invention is hereinafter described.

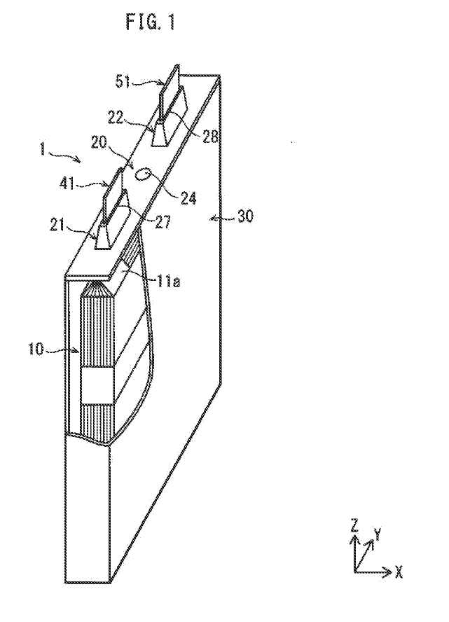

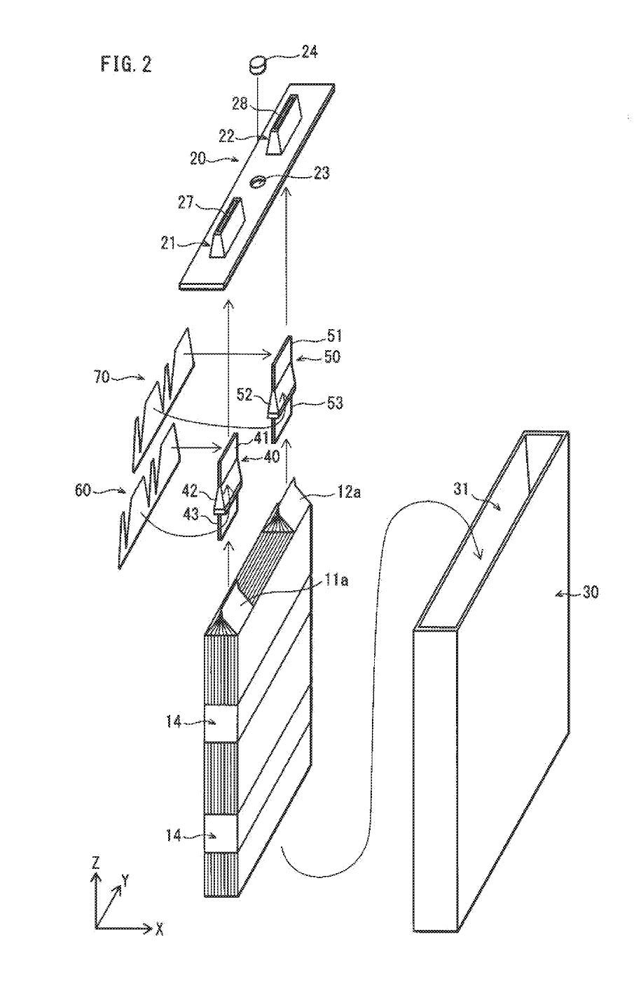

FIG. 1 is a perspective view diagram illustrating the battery 1 pertaining to the Embodiment. FIG. 2 is an assembly diagram of the battery 1. In FIGS. 1 and 2, the X arrow indicates the forward direction, the Y arrow indicates the lateral direction, and the Z arrow indicates the upward direction.

(Overall Structure of Battery 1)

The battery 1 is a square lithium-ion secondary-cell battery. As shown in FIG. 1, the battery 1 is made up of a casing 30 containing a laminated electrode assembly 10 and an electrolyte solution. A lid 20 is welded to the casing 30 at an opening 31 thereof.

The casing 30 is a bottomed prismatic quadrilateral formed from Al plates. The opening 31 is rectangular. The opening 31 is closed by fitting the lid 20 thereon. The lid 20 is a rectangular plate of Al.

A cathode terminal board 40 and an anode terminal board 50 are arranged so as to pass through the lid 20. An exterior terminal 41 for the cathode terminal board 40 and an exterior terminal 51 for the anode terminal board 50 project out of the top face of the lid 20.

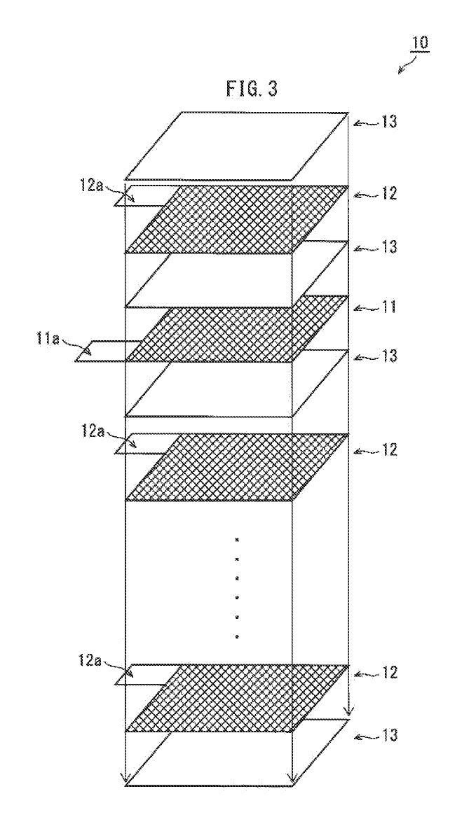

FIG. 3 shows the configuration of the laminated electrode assembly 10.

As shown in FIG. 3, the laminated electrode assembly 10 is made up of cathode plates 11 and anode plates 12, disposed in alternation with separators 13 interleaved therebetween. In the laminated electrode assembly 10, the quantity of anode plates 12 greater than the quantity of cathode plates 11 by one unit, for a total of 51 anode plates and 50 cathode plates. After interleaving, separators 13 come to be the outermost components of the laminated electrode assembly 10.

Insulating tape 14 is wrapped around the laminated electrode assembly 10 to fix the cathode plates 11 and anode plates 12, preventing slippage thereof.

Each cathode plate 11 is made up of Al foil, acting as an cathode current collector, with LiCoO₂ serving as cathode active material, carbon black serving as conductive material, and PVDF (Polyvinylidene Fluoride) serving as a binding agent, all combined into cathode active material layers on both surfaces of the foil.

The cathode plates 11 are rectangular in overall shape.

Each cathode plate 11 has a cathode tab 11a extending from the cathode current collector. Each cathode tab 11a is formed so as to project from one side of the cathode plate 11. The cathode tab 11a is made of the same Al foil as the cathode current collector, but has no cathode active material layers formed thereon.

Each anode plate 12 is made up of Cu foil, acting as an anode current collector, with graphite powder serving as anode active material and PVDF (Polyvinylidene Fluoride) serving as a binding agent, combined into anode active material layers on both surfaces of the foil.

The anode plates 12 are rectangular in overall shape, and are slightly bigger than the cathode plates 11.

Each anode plate 12 also has an anode tab 12a extending from the anode current collector, formed so as to project from one side thereof. The anode tab 12a is also made of the same Cu foil as the anode current collector, but has no anode active material layers formed thereon.

The separators 13 are made of PP (polypropylene), and are rectangular, substantially having the same dimensions as the anode plates 12.

The electrolyte solution is a non-aqueous solution, such as a mixed solvent combining EC (ethylene carbonate) and MEC (methyl ethyl carbonate) in a 30:70 ratio, with LiPF₆ dissolved therein at a concentration of 1M (1 mol/L).

(Features of Lid 20)

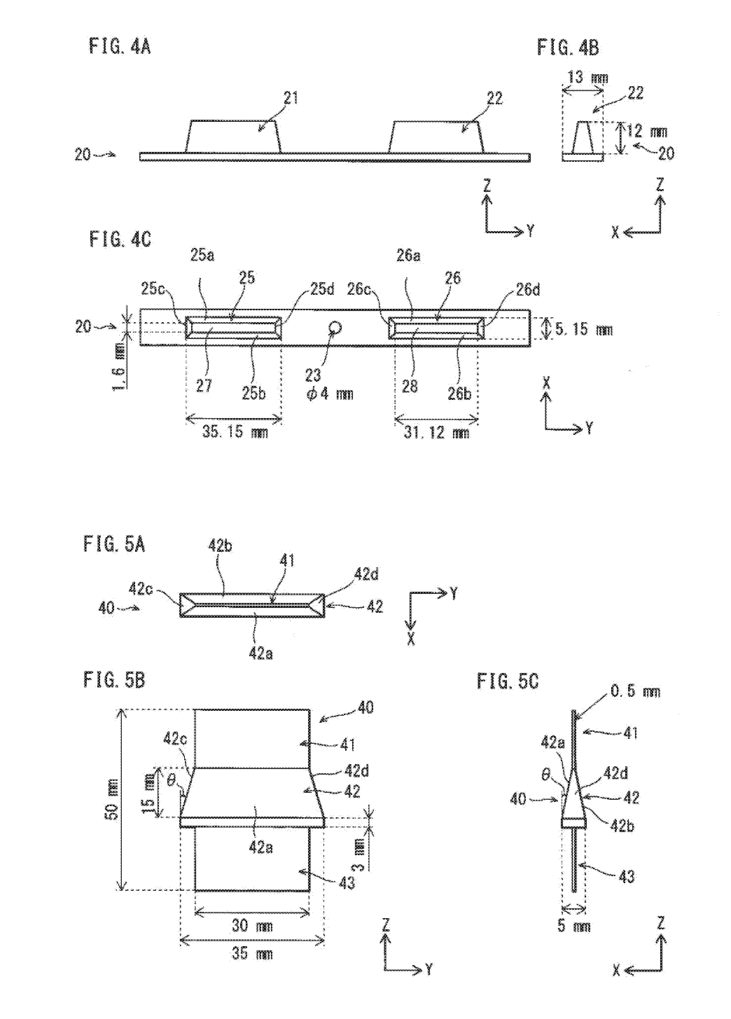

FIGS. 4A, 4B, and 4C illustrate the shape of the lid 20. FIG. 4A is a front view, FIG. 4B is a side view, and FIG. 4C is a bottom view of the lid 20.

The lid 20 is shaped so to have protrusions 21 and 22 protruding upward where the cathode terminal board 40 and the anode terminal board 50 pass through. The protrusions 21 and 22 are longer in the lateral direction (the Y dimension) than in the cross direction (the X dimension). The protrusion 21 encloses a through-hole 25 in which fits a fitting portion 42 of the cathode terminal board 40. The protrusion 22 encloses a through-hole 26 in which fits a fitting portion 52 of the anode terminal board 50.

The through-holes 25 and 26 have the shape of truncated pyramids, thinned in the cross direction (the X dimension). The holes become progressively narrower both crosswise (in the X dimension) and lengthwise (in the Y dimension) approaching the top from the bottom.

The protrusions 21 and 22 have the same shape and size as the through-holes 25 and 26.

To be exact, the through-hole 25 has four trapezoidal inner faces 25a-25d. The through-hole 26 has four similarly trapezoidal inner faces 26a-26d. Each of the inner faces 25a-25d and 26a-26d is slanted with respect to the Z-axis, having a tapering angle of θ.

The opening 27 of the through-hole 25 is formed at the peak of the protrusion 21. Similarly, the opening 28 of the through-hole 26 is formed at the peak of the protrusion 22.

The lid 20 has an infusion hole 23 formed at the centre thereof. The infusion hole 23 is closed by a rivet 24.

(Cathode Terminal Board and Anode Terminal Board Configuration)

The cathode terminal board 40 and the anode terminal board 50 are board-shaped members made of electrically conductive material extended in the Y-Z plane. The cathode terminal board 40 and the anode terminal board 50 are fit so as to pass through the through-holes 25 and 26 in the protrusions 21 and 22 of the lid 20 and connect to the cathode tabs 11a and the anode tabs 12a of the laminated electrode assembly 10, thus becoming exterior terminals.

FIGS. 5A, 5B, and 5C illustrate the shape of the cathode terminal board 40. FIG. 5A is a top view, FIG. 5B is a front view, and FIG. 5C is a side view.

The exterior terminal 41 is formed by the upper portion of the cathode terminal board 40, protruding upward from the protrusion 21 of the lid 20. The exterior terminal 41 is shaped as a rectangular plate of constant width (in the Y dimension). The product (cross-sectional area) of the plate thickness (X dimension) and width (Y dimension) is set according to the current in the battery 1, when in use.

The fitting portion 42 forming the middle portion of the cathode terminal board 40 passes through the through-hole 25 of the lid 20. To this end, the fitting portion 42 is shaped as a truncated square pyramid, becoming progressively wider in the cross direction (X dimension) and in the lateral direction (Y dimension) approaching the bottom. That is, the fitting portion 42 has four trapezoidal outer faces 42a-42d shaped to match the inner faces 25a-25d of the above-described through-hole 25. Each of the outer faces 42a-42d is slanted with respect to the Z-axis, also having a tapering angle of θ.

The wider the tapering angle θ of the outer faces 42a-42d of the fitting portion 42 and the inner faces 25a-25d of the through-hole 25 is set, the more the later-described process of welding the cathode terminal board 40 to the lid 20 is simplified, in that surface pressure can more easily be applied between the through-hole 25 and the fitting portion 42. Also, the fitting portion 42 can easily be fit in the through-hole 25 when the tapering angle θ is set wide enough.

The connecting portion 43 forming the bottom portion of the cathode terminal board 40 is rectangular, and is connected to the cathode tabs 11a of the laminated electrode assembly 10.

The cathode terminal board 40, shaped as described, is manufactured by pressing a plate of Al.

The anode terminal board 50 has the same shape as the cathode terminal board 40. The upwardly-protruding exterior terminal 51 and the connecting portion 53 connected to the anode tabs 12a of the laminated electrode assembly 10 are rectangular. The fitting portion 52 is shaped as a truncated square pyramid that fits in the through-hole 26 of the lid 20, becoming progressively wider in the cross direction and in the lateral direction approaching the bottom.

The anode terminal board 50 is manufactured by pressing a Cu member and applying Ni plating to the member so pressed.

(Sealing with Heat-Welding Tape)

Heat-welding tape 60 has been introduced between the outer faces of the fitting portion 42 of the cathode terminal board 40 and the inner faces of the through-hole 25 of the lid 20. The heat-welding tape 60 serves to fix the cathode terminal board 40 to the lid 20 such that the two components are insulated and sealed.

Heat-welding tape 70 is introduced between the outer faces of the fitting portion 52 of the anode terminal board 50 and the inner faces of the through-hole 26 of the lid 20. This heat-welding tape 70 serves to fix the anode terminal board 50 to the lid 20 such that the two components are insulated and sealed.

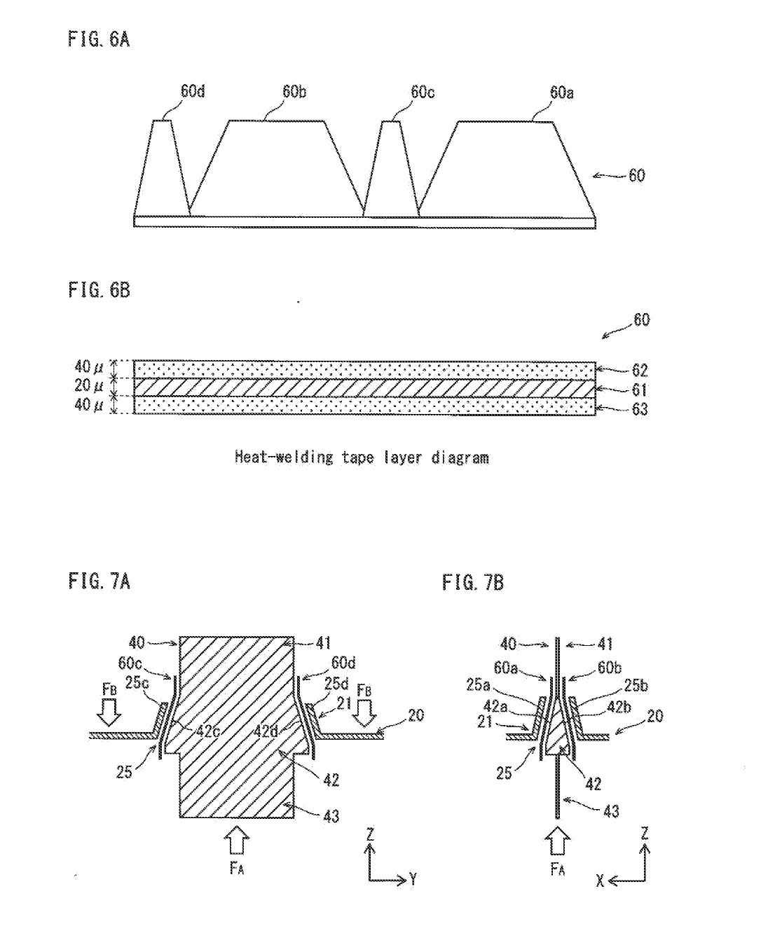

FIG. 6A shows a plan view of the heat-welding tape 60. FIG. 6B shows a schematic cross-section of the heat-welding tape 60.

The heat-welding tape 60 is shaped so as to cover the entire outer surface of the fitting portion 42 of the cathode terminal board 40. Specifically, as shown in FIG. 6A, the heat-welding tape 60 has planar portions 60a, 60b, 60c, and 60d, corresponding to the four trapezoidal outer faces of the fitting portion (i.e., the front face 42a, the back face 42b, the left face 42c, and the right face 42d).

Also, as shown in FIG. 6B, the heat-welding tape 60 is made up of an insulating substrate 61 with a heat-welding layer 62 and another heat-welding layer 63 layered on each principal surface thereof.

The heat-welding layers 62 and 63 are formed of material with a lower melting point than the insulating substrate 61.

Specifically, the insulating substrate 61 is made of a material with a melting point of 250° C. or higher, while the heat-welding layers 62 and 63 are made of a material with a melting point under 200° C.

In this example, the insulating substrate 61 is made of polyethylene naphthalate (PEN: melting point 265° C. to 270° C.; glass transition point 113° C.) and has a thickness of 20 μm, or, alternatively, of polyethylene terephthalate (PET: melting point 264° C.) or the like. The heat-welding layers 62 and 63 are made of polypropylene (PP: melting point 160° C. to 170° C.) and have a thickness of 40 μm.

The heat-welding tape 60 is disposed between the outer faces of the fitting portion 42 and the inner faces of the through-hole 25. The heat-welding layers 62 and 63 are melted through the application of heat, thus sealing the outer faces of the fitting portion 42 to the inner faces of the through-hole 25.

Heat-welding tape 70 has the same structure as heat-welding tape 60 and is shaped so as to cover the entire outer surface of the fitting portion 52 of the anode terminal board 50. This heat-welding tape 70 is made up of an insulating substrate with heat-welding layers layered on each principal surface thereof. This heat-welding tape 70 is disposed between the outer faces of the fitting portion 52 and the inner faces of the through-hole 26. The heat-welding layers are welded through the application of heat, thus sealing the outer faces of the fitting portion 52 to the inner faces of the through-hole 26.

In the above-described cathode terminal board 40, a surface roughening treatment may be applied to the outer faces of the fitting portion 42. Such a process facilitates the adhesion of the heat-welding layer 62 of the heat-welding tape 60 onto the fitting portion 42 and serves to improve the bond between the heat-welding tape 60 and the fitting portion 42 after welding of the heat-welding layer 62. The surface may be roughened by sandblasting, which involves spraying with fine particles of iron, glass, or similar, to physically roughen the surface. Alternatively, an etching liquid may be used to chemically roughen the surface.

Likewise, for the anode terminal board 50, a surface roughening treatment may be applied to the outer faces of the fitting portion 52. Such a process facilitates the adhesion of the heat-welding tape 70 and serves to improve the bond after welding.

(Battery 1 Manufacturing Method)

A manufacturing method for the battery 1 is described below.

1. Lid 20, Casing 30, Cathode Terminal Board 40, Anode Terminal Board 50 Manufacture

The lid 20, the casing 30, the cathode terminal board 40, and the anode terminal board 50 are formed by pressing metal. The dimensions of the lid 20, the cathode terminal board 40, and the anode terminal board 50 are as given in FIGS. 5B and 5C.

2. Cathode Plate Manufacture

A cathode slurry is prepared by combining LiCoO₂, serving as the cathode active material, at 90 mass percent; carbon black, serving as the conductive material, at 5 mass percent; PVDF (polyvinylidene fluoride), serving as the binding agent, at 5 mass percent, and NMP (N-methyl-2-pyrrolidone) serving as the solvent. Then, the cathode slurry is applied to both surfaces of the Al foil (thickness: 15 μm) serving as the cathode current collector.

Afterward, once the solvent is dried, the cathode plate 11 is formed by pressing with a roller until a thickness of 0.1 mm is achieved and then cutting the plate into a rectangle (95 mm wide by 115 mm tall) with the cathode tab 11a, which is 30 mm wide by 20 mm tall, extending therefrom.

The cathode material may be other than LiCoO₂ as described above. For example, LiNiO₂, LiMn₂O₄, or a compound thereof may be used.

3. Anode Plate Manufacture

An anode slurry is prepared by combining graphite powder, serving as the anode active material, at 95 mass percent; PVDF (polyvinylidene fluoride), serving as the binding agent, at 5 mass percent, and NMP (N-methyl-2-pyrrolidone) serving as the solvent. This slurry is then applied to both surfaces of a Cu foil (thickness: 10 μm) serving as the anode current collector. The graphite powder may be derived from natural or artificial graphite, as preferred.

Afterward, once the solvent is dried, the anode plate 12 is formed by pressing with a roller until a thickness of 0.08 mm is achieved and then cut into a rectangle (100 mm wide by 120 mm tall) with the anode tab 12a, which is 30 mm wide by 20 mm tall, extending therefrom.

4. Laminated Electrode Assembly Manufacture

As shown in FIG. 3, the laminated electrode assembly 10 is formed by the cathode plates 11 (quantity: 50) and the anode plates 12 (quantity: 51) disposed in alternation with the separators 13 interleaved therebetween such that separators 13 come to be at the outermost positions. Each of the separators 13 has a width of 100 mm, a height of 120 mm, and a thickness of 30 μm.

Also, as shown in FIG. 2, the insulating tape 14 is wrapped so as to bind the laminated electrode assembly 10.

As seen in a plan view, a bundle of cathode tabs 11a and a bundle of anode tabs 12a project from the laminated electrode assembly 10.

5. Heat-Welding Tape Adhesion to Terminal Boards

The cathode terminal board 40 is heated to 200° C. Heat-welding tape 60 is then attached to the entire outer surface of the fitting portion 42 thereof.

Similarly, the anode terminal board 50 is heated to 200° C. Heat-welding tape 70 is then attached to the entire outer surface of the fitting portion 52 thereof.

6. Welding Terminals 40, 50 onto Lid 20

The lid 20 is set using a heater-equipped jig (not diagrammed). Meanwhile, the cathode terminal board 40, with heat-welding tape 60 adhering thereto, and the anode terminal board 50, with heat-welding tape 70 adhering thereto, are set in the through-holes 25 and 26 of the lid 20. A press jig (not diagrammed) is used to press the cathode terminal board 40 and the anode terminal board 50 into the lid 20.

Thus, the heat-welding tape 60 and 70 automatically comes to be disposed between the outer faces of the cathode terminal board 40 and anode terminal board 50 and the inner faces of the through-holes 25 and 26 when the terminal boards 40 and 50, with heat-welding tape 60 and 70, respectively, adhering thereto, are pressed into the through-holes 25 and 26.

FIGS. 7A and 7B show cross-sectional diagrams of the cathode terminal board 40, with heat-welding tape 60 adhering to the fitting portion 42 thereof, fitting in the through-hole 25 of the lid 20 as pressure is being applied. FIG. 7A shows a transverse cross-section of the cathode terminal board 40, while FIG. 7B shows a longitudinal cross-section of the same cathode terminal board 40.

In FIGS. 7A and 7B, the arrow outline F_{A} indicates the force applied by the press jig pressing the cathode terminal board 40. Similarly, the arrow outline F_{B} indicates the accompanying force applied by the heater-equipped jig pressing the lid 20.

The four faces of the fitting portion 42 (the front face 42a, the back face 42b, the left face 42c, and the right face 42d) and the correspondingly opposite inner faces 25a-25d of the through-hole 25 are tapered at an angle (slanted with respect to the Z-axis). Thus, when the press jig presses the cathode terminal board 40 as described above, the outer faces of the fitting portion 42 and the inner faces of the through-hole 25 come to press and sandwich the heat-welding tape 60 therebetween, applying surface pressure to both sides. The surface pressure is approximately equal to F_{A}×sin θ (where θ is the tapering angle). The wider the tapering angle, the greater the surface pressure that can be easily applied.

While pressure is maintained by the pressing jig at a constant magnitude (such as 0.8 MPa), the heater is activated to heat the lid 20 for three seconds at 200° C. Accordingly, the heat-welding layers 62 and 63 of the heat-welding tape 60 are melted, thus sealing the space between the outer faces of the fitting portion 42 and the inner faces of the through-hole 26 and fixing the cathode terminal board 40 to the lid 20.

7. Terminal Board and Laminated Electrode Assembly Connection

As shown in FIG. 2, the cathode terminal board 40 and the anode terminal board 50, which are fixed to the lid 20, are connected to the bundle of cathode tabs 11a and to the bundle of anode tabs 12a, respectively. The bundles are part of the laminated electrode assembly 10. This connection may be achieved by, for example, ultrasonic welding.

In this example, the cathode terminal board 40 and the anode terminal board 50 are connected to the laminated electrode assembly 10 after having been welded to the lid 20. However, the order of operations may be reversed, such that the cathode terminal board 40 and the anode terminal board 50 are connected to the laminated electrode assembly 10 first, and subsequently welded to the lid 20.

8. Filling and Sealing Laminated Electrode Assembly in Casing

The laminated electrode assembly 10 is inserted into the casing 30. The lid 20 is fit onto the opening 31 of the casing 30, thus closing the opening 31. The perimeter of the lid 20 is laser-welded to the open edge of the casing 30, thus sealing the components together.

9. Filling and Sealing of Electrolyte Solution

In an Ar substitution environment, the electrolyte solution is infused through the infusion hole 23. The infusion hole 23 is then sealed by the rivet 24. The battery 1 is thus completed.

(Battery 1 Effects)

Heat-welding tape 60 is disposed between the outer faces 42a-42d of the fitting portion 42 of the cathode terminal board 40 and the inner faces 25a-25d of the through-hole 25 of the lid 20. This heat-welding tape 60 is made up of heat-welding layers 62 and 63 layered on both principal surfaces of the insulating substrate 61. Therefore, a good-quality seal is achieved between the outer faces 42a-42d of the fitting portion 42 and the inner faces 25a-25d of the through-hole 25 of the lid 20. Also, the cathode terminal board 40 is solidly fixed to the lid 20 while being securely insulated therefrom.

In other words, as in the above-detailed manufacturing method, heat-welding is performed while the cathode terminal board 40 is being pressurized. Once the heat-welding layers 63 and 64 melt while the outer faces 42a-42d of the fitting portion 42 and the inner faces 25a-25d of the through-hole 25 press and sandwich heat-welding tape 60 therebetween, a good-quality seal is assured and the cathode terminal board 40 is solidly fixed to the lid 20.

Furthermore, the heat-welding tape 60 incorporates the insulating substrate 61, which does not melt at temperatures such as the welding temperature of 200° C. Thus, despite the heat-welding performed during pressing, as described above, the cathode terminal board 40 and the lid 20 are securely insulated from one another by the insulating substrate 61.

Similarly, heat-welding tape 70 is placed between the outer faces of the fitting portion 52 of the anode terminal board 50 and the inner faces of the through-hole 26 of the lid 20. Then, given that this heat-welding tape 70 is also made up of heat-welding layers layered on both principal surfaces of an insulating substrate, a good-quality seal is formed in the space between the outer faces 52a-52d of the fitting portion 52 and the inner faces 26a-26d of the through-hole 26 of the lid 20. Also, the anode terminal board 50 is solidly fixed to the lid 20, and the two components are securely insulated from each other.

Under conventional technology, terminal members are fixed to the lid using a nut by passing through a washer and an insulating board. However, according to the battery 1 of the present Embodiment, a nut or similar component is not required in order to fix the terminal boards to the lid. Therefore, the total number of components is accordingly reduced.

Furthermore, according to the battery 1 of the present Embodiment, the through-holes 25 and 26 and the fitting portions 42 and 52 fitting therein are tapered. In particular, as shown in FIGS. 5B and 5C, the components are tapered in the Y-Z plane as well as in the X-Z plane. Thus, during the welding process for the heat-welding tape 60 and 70, the cathode terminal board 40 with heat-welding tape 60 wrapped therearound and the anode terminal board 50 with heat-welding tape 70 wrapped therearound need only be fit and pressed into the through-holes 25 and 26 of the lid 20 in order to cause the outer faces of the fitting portions 42 and 52 and the inner faces of the through-holes 25 and 26 to press against one another.

Accordingly, the welding process, in which the heat-welding tape 60 and 70 is melted, is simplified.

In addition, the through-holes 25 and 26 are formed inside the protrusions 21 and 22. Thus, the contact surface area between the lid 20 and the cathode terminal board 40 and anode terminal board 50 is made greater. That is, the through-holes 25 and 26 are made longer, thus extending the surface area of the inner faces 25a-25d of through-hole 25 and the inner faces 26a-26d of through-hole 26. Correspondingly, the fitting portions 42 and 52 are made longer, thus expanding the surface area of the outer faces 42a-42d and 52a-52d.

Therefore, the seal between the lid 20 and the cathode terminal board 40 and anode terminal board 50 is improved. Also, the cathode terminal board 40 and anode terminal board 50 are securely fixed to the lid 20.

In addition, in the battery 1, the lid 20 is laterally extended but is relatively slim (thin in the X dimension). However, given that the cathode terminal board 40 and anode terminal board 50 are laterally extended plates, a sufficient cross-sectional area for the terminals passing through the lid 20 can be assured.

(Other Points of Interest)
(1) In the battery 1 of the above-described Embodiment, the casing and the lid are made of Al. However, stainless steel may also be used, as may any other metal or metal alloy.
(2) According to the battery 1 of the above-described Embodiment, the four faces of the fitting portion 42 (the front face 42a, the back face 42b, the left face 42c, and the right face 42d) and the correspondingly opposite inner faces 25a-25d of the through-hole 25 are tapered at an angle (slanted with respect to the Z-axis). Thus, the through-hole 25 and the fitting portion 42 apply mutual surface pressure on four faces during the welding process of the cathode terminal board 40 onto the lid 20. However, the same effect can be produced by tapering one or more of the four faces (the front face 42a, the back face 42b, the left face 42c, or the right face 42d) and the corresponding one or more inner faces of the through-hole 25 in at least one of the Y-Z and X-Z planes such that the tapered faces of the through-hole 25 and the fitting portion 42 apply mutual surface pressure during the welding process of the cathode terminal board 40 onto the lid 20.

The same applies to the four faces 52a-52d of the fitting portion 52 of the anode terminal board 50 and the correspondingly opposite inner faces 26a-26d of the through-hole 26.
(3) According to the battery 1 pertaining to the above-described Embodiment of the present invention, protrusions 21 and 22 are formed in the lid 20, with the through-holes 25 and 26 being formed inside the protrusions 21 and 22, thus providing the advantageous seal-improving effect and the secure fixing effect. However, the through-holes through which the electrode terminal boards pass need not necessarily be formed in protrusions. The through-holes may be formed in the lid without any protrusions.
(4) In the battery 1 of the above-described Embodiment, the cathode terminal board 40 and the anode terminal board 50 each pass through one of the through-holes 25 and 26 formed in the lid 20. However, the battery may also be realized with only one of the cathode terminal board and the anode terminal board passing through the lid.
(5) In the battery 1 pertaining to the above-described Embodiment, the cathode terminal board 40 and the anode terminal board 50 are shaped to match the cross dimension of the lid 20, and the fitting portions 42 and 52 thereof are shaped as truncated, square, pyramids. However, if the lid is made wider in the cross dimension, then the electrode terminals need not be boards, and the fitting portions 42 and 52 need not be flat.

For example, the electrode terminals may be rectangular prisms or cones, and the fitting portions thereof may be truncated pyramids or cylinders. The same effects can be realized with this configuration.
(6) In the above-described manufacturing method for the battery 1, process 5, in which the heat-welding tape 60 and 70 is made to adhere to the terminal boards 40 and 50, is performed before process 6, in which the terminal boards 40 and 50 are fixed (by welding to the lid 20) in the through-holes 25 and 26. However, process 6 may be performed without the heat-welding tape 60 and 70 having been made to adhere to the terminal boards 40 and 50 in advance during process 5. In such a case, the same heat-welding process can be performed by introducing the heat-welding tape 60 and 70 between the outer faces of the terminal boards 40 and 50 and the inner faces of the through-holes 25 and 26 when the terminal boards 40 and 50 are fit into the through-holes 25 and 26 for process 6.
(7) The present invention is not particularly limited to the structure of electrodes, but may also, for instance, be applied to a flat spiral square-cell battery. Also, the battery is not limited to a square shape, but may also be applied to a spiral-cell or cylindrical battery.

In addition, the present invention is not limited to Lithium-ion secondary cell batteries, but may also be applied to other types of batteries.

### INDUSTRIAL APPLICABILITY

The present invention is applicable to a relatively high-capacity battery for use as a back-up power supply in robots and electric vehicles, and in particular to a square cell battery.

### REFERENCE SIGNS LIST

1 Battery
10 Laminated electrode assembly
11 Cathode plates
11a Cathode tabs
12 Anode plates
12a Anode tabs
13 Separators
14 Insulating tape
20 Lid
21, 22 Protrusions
25, 26 Through-holes
25a-25d Inner faces
26a-26d Inner faces
27, 28 Openings
30 Casing
31 Opening
40 Cathode terminal board
41 Exterior terminal
42 Fitting portion
42a-42d Outer faces
43 Connecting portion
50 Anode terminal board
51 Exterior terminal
52 Fitting portion
52a-52d Outer faces
53 Connecting portion
60, 70 Heat-welding tape
61 Insulating substrate
62, 63 Heat-welding layers

1. A battery comprising:
a casing having an opening;
an electrode assembly contained in the casing and in which are disposed a cathode plate and an anode plate interleaved with a separator;
an electrode terminal connected to the cathode plate or to the anode plate;
a lid closing the opening and having a through-hole formed therein such that the electrode terminal passes therethrough; and
a heat-welding sheet having a laminate structure in which at least one heat-welding layer is laminated on an insulating substrate; wherein
a passing portion of the electrode terminal passing through the through-hole is shaped so as to fit the through-hole, and
the heat-welding sheet has been introduced between outer faces of the passing portion of the electrode terminal and inner faces of the through-hole and provides insulation and sealing between the electrode terminal and the lid

2. The battery of claim 1, wherein
the through-hole is tapered so as to decrease in width toward the distal end relative to the electrode assembly, and
the passing portion of the electrode terminal is tapered to fit the through-hole.

3. The battery of claim 2, wherein
the lid has a protrusion protruding from an outside face thereof, and
the through-hole is a hole in the protrusion.

4. The battery of claim 1, wherein
the lid has a protrusion protruding from an outside face thereof, and
the through-hole is a hole in the protrusion.

5. The battery of claim 1, wherein
the outer faces of the electrode terminal have been roughened by a treatment.

6. The battery of claim 1, wherein
the heat-welding layer is made of a material having a lower melting point than the insulating substrate.

7. The battery of claim 6, wherein
the insulating substrate is made of a material having a melting point of at least 250° C.

8. The battery of claim 1, wherein
the casing is a rectangular prism.

9. A battery manufacturing method for manufacturing the battery of claim 1, comprising:
a fitting step of fitting the electrode terminal in the through-hole formed in the lid such that the heat-welding sheet is interposed; and
a welding step of welding the heat-welding sheet by heating the lid while the electrode terminal is fitted in the through-hole.

10. The battery manufacturing method of claim 9, further comprising
an adhering step of causing the heat-welding sheet to adhere to the outer faces of the electrode terminal by welding, the adhering step being performed before the fitting step.

11. The battery manufacturing method of claim 9, wherein
the through-hole is tapered so as to decrease in width toward the distal end relative to the electrode assembly, and
the passing portion of the electrode terminal is tapered to fit the through-hole.

12. The battery manufacturing method of claim 11, wherein
the lid has a protrusion protruding from an outside face thereof, and
the through-hole is a hole in the protrusion.

13. The battery manufacturing method of claim 9, wherein
a surface roughening treatment is applied to the outer faces of the electrode terminal.

14. The battery manufacturing method of claim 9, wherein
the heat-welding layers are made of a material having a lower melting point than the insulating substrate.

15. The battery manufacturing method of claim 14, wherein
the insulating substrate is made of a material having a melting point of at least 250° C.
